(19) United States
(12) Patent Application Publication
(10) Pub. No.: US 2006/0208158 A1
(43) Pub. Date: Sep. 21, 2006

(54) Solid-state image device, driving method thereof, and camera

(75) Inventor: Murakami Masashi, Soraku-gun (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co. Ltd., Osaka (JP)

(21) Appl. No.: 11/362,190

(22) Filed: Feb. 27, 2006

(30) Foreign Application Priority Data
Feb. 28, 2005 (JP) 2005-052845

(51) Int. Cl. H01L 27/00

(52) U.S. Cl. 250/208.1

(57) ABSTRACT

An object of the present invention is to provide a solid-state imaging device which is capable of suppressing horizontal shading in which light and shade is generated on a display screen in a left to right direction, without increasing the signal reading-out time, and the driving method of the device. It includes pixel cells, vertical signal lines, load transistors, sampling capacitors, a horizontal signal, and a load control circuit. The load control circuit controls the load transistors functioning as loads to become disabled between the ending time of the horizontal signal reading-out period in which pixel signals are read out from the sampling capacitors to a horizontal signal line and the starting time of the vertical signal reading-out period in which pixel signals are read out from the pixel cells to vertical signal lines.

### BACKGROUND OF THE INVENTION

(1) Field of the Invention

The present invention relates to a MOS solid-state imaging device and a driving method thereof, and in particular to a technique for suppressing image deterioration accompanying a current variation in the solid-state imaging device.

(2) Description of the Related Art

With regard to a MOS solid-state imaging device, there is a demand for reducing electricity consumption. As a solid-state imaging device which satisfies a demand like this, a technique of controlling a current flowing in the amplifying transistors placed in pixel cells has been disclosed in the Japanese Laid-open Patent Application No. 9-247537. More specifically, the following has been disclosed in the Application: a technique of changing a current flowing in the amplifying transistors by turning off load transistors connected to a vertical signal line at a transition boundary between (a) a vertical signal reading-out period for reading out pixel signals of pixel cells to a vertical signal line and (b) a horizontal signal reading-out period for reading out the pixel signals transmitted through the vertical signal line to a horizontal signal line.

In addition, with regard to a MOS solid-state imaging device, the Japanese Laid-open Patent Application No. 2003-46864 has disclosed a technique of turning ON or OFF the amplifying transistors by performing a periodic transition of the high potential and the low potential in the power supply voltage, instead of keeping a power supply voltage supplied to the respective cells constant, and causing only particular pixel cells to selectively output pixel signals without placing any switching transistors in the pixel cells.

### SUMMARY OF THE INVENTION

However, the above-mentioned solid-state imaging device, disclosed in the Japanese Laid-open Patent Application No. 9-247537, which changes a current at the transition boundary between a vertical signal reading-out period and a horizontal signal reading-out period has a problem described below.

Since a current is applied to the amplifying transistors of pixel cells in the vertical signal reading-out period, there occurs a voltage drop in a power supply which serves as a current supply. Subsequently, when the current supply to the amplifying transistors is stopped, the power supply voltage stops dropping and increases taking time which is determined based on a power supply capacity C and an impedance of a power supply line R. In general, C is approximately 10 μF, and R is approximately 5Ω, and the time constant CR is as much as 50μ seconds.

Consequently, as the conventional technique, when a current flowing in the amplifying transistors at the transition boundary between the vertical signal reading-out period and the horizontal signal reading-out period is changed, the horizontal reading-out operation starts immediately after the current variation. The variation of power supply voltage affects an image and there occurs a problem of an image defect due to horizontal shading in which light and shade is generated on a display screen in a left to right direction.

At this time, when the time for controlling the power supply variation is secured between the vertical signal reading-out period and the horizontal signal reading-out period in order to suppress horizontal shading, the time for reading out the pixel signals of the pixel cells corresponding to a line increases as a result. This results in the occurrence of another problem which is an increase in the time for obtaining an image.

Therefore, an object of the present invention is to provide a solid-state imaging device which is capable of suppressing the occurrence of horizontal shading accompanying a reduction in consumption electricity without increasing the time for reading out the signals, and the driving method thereof.

In order to achieve the above-mentioned object, the solid-state imaging device, of the present invention, includes: pixel cells which are arranged in a matrix and perform photoelectric conversion; vertical signal lines each to which pixel cells arranged in the same row are connected and which transmit pixel signals of the pixel cells in the row; load units in each row which are connected to each of the vertical signal lines; holding units in the each row which are connected to the each of the vertical signal lines and which hold the pixel signals of the pixel cells in the each row transmitted through the vertical signal lines; a horizontal signal line which is connected to holding units in the same line and which transmits the pixel signals in the holding units in the line; and a load control unit which controls the load units. In the device, the load control unit controls the load units functioning as loads to become disabled in a duration between the ending time of a horizontal signal reading-out period and the starting time of a vertical signal reading-out period. In the horizontal signal reading-out period the pixel signals are read out from the holding units to the horizontal signal line, and in the vertical signal reading-out period the pixel signals are read out from the pixel cells to the vertical signal lines. Here, it is preferable that, in the solid-state imaging device of the present invention, the load units be load transistors and the load control unit control the load transistors in an ON state to turn OFF in a duration between the ending time of the horizontal signal reading-out period and the starting time of the vertical signal reading-out period. In addition, it is preferable that the pixel power supply of the solid-state imaging device be an internal pixel power supply for the solid-state imaging device. In addition, it is preferable that the pixel power supply in the solid-state imaging device be an external pixel power supply for the solid-state imaging device.

This prevents the load unit from functioning as a load between the ending time of the horizontal signal reading-out period and the starting time of the vertical signal reading-out period. Therefore, it is possible to control the variation of power supply at the transition from the vertical signal reading-out period to the horizontal signal reading-out period. As a result, since the pixel signals read out to the horizontal signal line are not affected by the variation of the power supply, it is possible to suppress the occurrence of horizontal shading accompanying a reduction in consumption electricity.

In addition, horizontal shading is suppressed without securing the time for controlling the variation of the power supply between the vertical signal reading-out period and the horizontal signal reading-out period. As a result, it is possible to suppress the occurrence of horizontal shading accompanying a reduction in consumption electricity without increasing the signal reading-out time.

In addition, it is desirable that, in the solid-state imaging device, the pixel cells each includes: a photoelectric conversion unit which performs photoelectric conversion; a charge holding unit which holds a signal charge generated by the photoelectric conversion unit; a switch inserted between a pixel power supply which supplies potential to a pixel cell and the charge holding unit; and an amplifying unit which outputs a pixel signal corresponding to the signal charge of the charge holding unit. In addition, it is desirable that, in the solid-state imaging device, the pixel power supply supply potential. The potential is periodically changed between a first potential and a second potential which is higher than the first potential. In addition, it is desirable that, in the solid-state imaging device, the pixel power supply supply the second potential in the vertical signal reading-out period and changes the potential to be supplied to the pixel cells from the second potential to the first potential in the duration between the ending time of the horizontal signal reading-out period and the starting time of the vertical signal reading-out period, and the solid-state imaging device further includes a switch control unit which controls the switches to turn ON, while the second potential is being supplied during the vertical signal reading-out period, and while the first potential is being supplied in the duration between the ending time of the horizontal signal reading-out period and the starting time of the vertical signal reading-out period.

This makes it possible to reduce consumption electricity in a pixel cell disabled period of the solid-state imaging device disclosed in the Japanese Laid-open Patent Application No. 2003-46864 and the like. The pixel cell disabled period is the period during which non-selected pixel cells are disabled so as not to output pixel signals, in other words, the first potential is applied to the charge holding units.

In addition, it is desirable that, in the solid-state imaging device, the load control unit controls the load transistors in an ON state to turn OFF before the pixel power supply changes the potential from the second potential to the first potential.

This makes it possible to control the influence which the vertical signal line receives due to a potential variation from the second potential to the first potential of the pixel power supply. As a result, it is possible to prevent a problem that the potential of the charge holding units in the other pixel cells is increased due to the coupling of a vertical signal line and the charge holding units in pixel cells. In other words, it is possible to prevent the decrease of the dynamic ranges of the charge holding units.

In addition, the present invention may be a camera equipped with the above-described solid-state imaging device.

In this way, the camera which is capable of obtaining high quality images can be realized.

In addition, the present invention may be a method of driving such solid-state imaging device that includes: pixel cells which are arranged in a matrix and perform photoelectric conversion; vertical signal lines each to which pixel cells arranged in the same row are connected and which transmit pixel signals of the pixel cells in the row; load units in each row which are connected to each of the vertical signal lines; holding units in the each row which are connected to the each of the vertical signal lines and which hold the pixel signals of the pixel cells in the each row transmitted through the vertical signal lines; and a horizontal signal line which is connected to holding units in the same line and which transmits the pixel signals in the holding units in the line. The method includes: vertical reading-out of pixel signals from the pixel cells to the vertical signal lines; horizontal reading-out of pixel signals from the holding units to the horizontal signal line; and controlling of the load units functioning as loads to become disabled in a duration between an ending time of the horizontal reading-out and a starting time of the vertical reading-out. Here, it is desirable that, in the solid-state imaging device, the pixel cells each include: a photoelectric conversion unit which performs photoelectric conversion; a charge holding unit which holds a signal charge generated by the photoelectric conversion unit; a switch inserted between a pixel power supply which supplies potential to a pixel cell and the charge holding unit, the potential being periodically changed between a first potential and a second potential which is higher than the first potential; and an amplifying unit which outputs a pixel signal corresponding to the signal charge of the charge holding unit. Additionally, it is desirable that, in the method, vertical reading-out include causing the power supply to supply the second potential in a state where the switches are turned ON, and the controlling of the load units include changing the potential which the power supply supplies in the state where the switches are turned ON from the second potential to the first potential, after controlling the load units functioning as loads to become disabled.

In this way, it is possible to realize a method of driving a solid-state imaging device which is capable of suppressing the occurrence of horizontal shading accompanying a reduction in consumption electricity without increasing the signal reading-out time. In addition, it is possible to realize a method of driving a solid-state imaging device which is capable of preventing a problem of a decrease in the dynamic ranges.

With the present invention, it is possible to control the variation of the power supply voltage accompanying a current variation in the horizontal signal reading-out period during which the pixel signals held in the charge holding units are read out to the horizontal signal line. Therefore, it becomes possible to suppress a problem of an image defect due to horizontal shading in which light and shade is generated, accompanying a reduction in consumption electricity, on a display screen in a left to right direction. In addition, since horizontal shading is suppressed without securing the time for controlling the variation of the power supply between the vertical signal reading-out period and the horizontal signal reading-out period, it is possible to suppress horizontal shading accompanying the reduction in consumption electricity without increasing the signal reading-out time.

In particular, in the solid-state imaging device which allows only particular pixel cells to selectively output pixel signals by performing a periodic transition of the high potential and the low potential in power supply voltage instead of keeping the power supply voltage supplied to the respective cells constant, the pixel cells are disabled by turning the switch from ON to OFF while the voltage supplied to pixel cells by power supply is low after the horizontal signal reading-out period. Turning the load transistor off at this time makes it possible to control the potential variation of the vertical signal line accompanying this disabling of the pixel cell.

Consequently, it becomes possible to suppress the coupling, accompanying the potential variation of the vertical signal line, of the vertical signal line and the charge holding units in the non-selected pixel cells which have been disabled and suppress the decrease of the dynamic ranges of the charge holding units.

### FURTHER INFORMATION ABOUT TECHNICAL BACKGROUND TO THIS APPLICATION

The disclosure of Japanese Patent Application No. 2005-052845 filed on Feb. 28, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing the structure of a solid-state imaging device in a first embodiment of the present invention;

FIG. 2 is a timing chart showing an operation of the solid-state imaging device in the first embodiment of the present invention;

FIG. 3 is a variation of the timing chart showing the operation of the solid-state imaging device in the first embodiment of the present invention; and

FIG. 4 is a diagram showing the structure of a camera in a second embodiment of the present invention.

### DESCRIPTION OF THE PREFERRED EMBODIMENT(S)

Embodiments of the present invention will be described in detail with reference to figures.

### First Embodiment

This embodiment relates to a solid-state imaging device which controls power supply variation, accompanying a reduction in consumption electricity, in a horizontal signal reading-out period by performing control of a current flowing in the amplifying transistors of pixel cells, not immediately before the starting time of the horizontal signal reading-out period but after the ending time of the horizontal reading-out period. In particular, it relates to a solid-state imaging device which allows only particular pixel cells to selectively output pixel signals by performing a periodic transition of HIGH potential and LOW potential in the power supply voltage instead of keeping the power supply voltage supplied to the respective pixel cells constant. Performing control of a current of the amplifying transistors between the ending time of the horizontal signal reading-out period and the time of resetting the selection of pixel cells makes it possible to control variation of the power supply voltage accompanying the current variation in the horizontal signal reading-out period without increasing the reading-out time. Therefore, it is possible to suppress a problem of an image defect due to horizontal shading in which light and shade is generated, accompanying a reduction in consumption electricity, on a display screen of the solid-state imaging device in a left to right direction, without increasing the reading-out time.

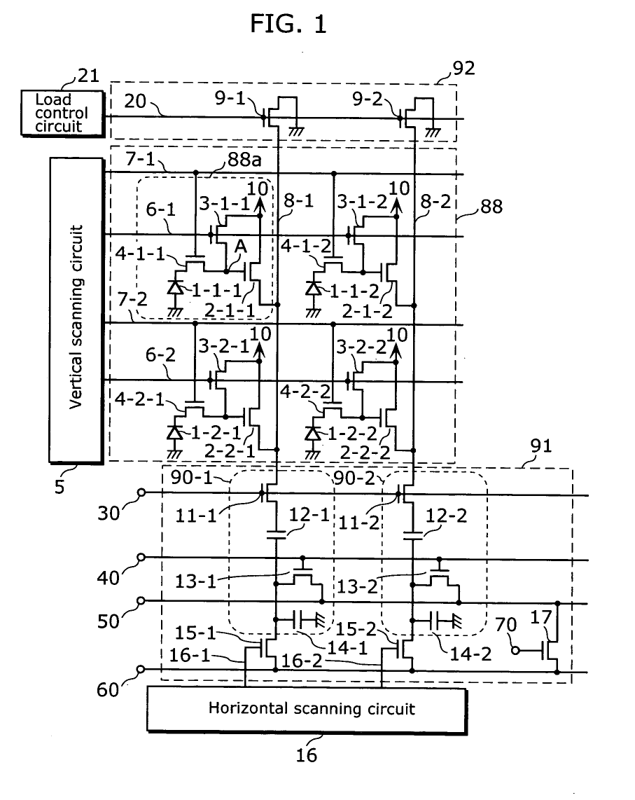

FIG. 1 is a diagram showing the structure of a solid-state imaging device in the first embodiment of the present invention.

This solid-state imaging device includes: an imaging unit 88, a vertical scanning circuit 5, a horizontal scanning circuit 16, a line signal processing unit 91, a load circuit 92, and a load control circuit 21, and reads out a pixel signal which each pixel cell 88a outputs depending on the amount of received light. Note that the respective vertical scanning circuit 5 and load control circuit 21 are examples of a switch control unit and a load control unit of the present invention.

The respective pixel cells 88a are arranged in a matrix in the imaging unit 88. The pixel cells 88a of each row are connected to each of vertical signal lines 8-1 and 8-2, and the pixel cells 88a of each line are connected to each of read signal lines 7-1 and 7-2 and each of reset signal lines 6-1 and 6-2. The respective vertical signal lines 8-1 and 8-2 placed for each row of the pixel cells 88a are connected to the line signal processing unit 91 and the horizontal scanning circuit 16, and transmit the pixel signals of the pixel cells 88a. The respective read signal lines 7-1 and 7-2 and reset signal lines 6-1 and 6-2 placed for each line of the pixel cells 88a are connected to the vertical scanning circuit 5. The reference numbers of the respective signal lines are abbreviated hereinafter, for example as a vertical signal line 8.

The pixel cells 88a are composed of photoelectric conversion elements 1-1-1 to 1-2-2, amplifying transistors 2-1-1 to 2-2-2, reset transistors 3-1-1 to 3-2-2, and read transistors 4-1-1 to 4-2-2. The reference numbers of the respective elements are abbreviated hereinafter, for example as a photoelectric conversion element 1. Note that the respective photoelectric conversion elements 1, amplifying transistors 2, and reset transistors 3 are examples of the photoelectric conversion units, amplifying units, and switches of the present invention.

A charge holding unit of a pixel cells 88a is a gate input unit of an amplifying transistor 2, and corresponds to a node (A in FIG. 1) connected to both a read transistor 4 and a reset transistor 3. Note that the charge holding unit is an example of the charge holding unit of the present invention.

More specifically, the charge holding units of the respective pixel cells 88a correspond to PN junctions within the respective integrated circuits. They hold potential by holding charges generated by the photoelectric conversion elements 1, and controls a current applied from power supply 10, which is connected to the amplifying transistors 2, to the vertical signal line 8 depending on the potential. Note that a power supply 10 is an example of the pixel power supply of the present invention.

The photoelectric conversion elements 1 generate charges depending on the amount of received light through photoelectric conversion.

The read transistors 4 are normally in an OFF state. They are turned ON only while the potential of the read pulse applied to the read signal line 7 is HIGH, and transmit the charges generated by the photoelectric conversion elements 1 to the charge holding units.

The reset transistors 3 are switches inserted between the power supply 10 and the respective charge holding units. The reset transistors 3 are normally in an OFF state. They are turned ON only while the potential of the reset pulse applied to the reset signal line 6 is HIGH, and supply the potential of the power supply 10 to the charge holding units.

The amplifying transistors 2 output pixel signals depending on the amount of charges held by the charge holding units.

Here, the power supply 10 of the respective pixel cells 88a are outputs to the pixel cells 88a from the power supply circuit in which the potential periodically transits between HIGI and LOW. Since the pixel cells 88a are structured in the above described manner, when the reset transistors 3 are turned ON while the potential of the power supply 10 is HIGH, the potential of the charge holding units become HIGH. Accompanying this, the amplifying transistors 2 are turned ON, the current flows from the power supply 10 to the vertical signal line 8, and the potential of the vertical signal line 8 increases to a reference potential.

Subsequently, when the read transistors 4 are turned ON so as to electrically connect the photoelectric conversion elements 1 and the charge holding units, the potential of the charge holding units decreases depending on the amount of charges generated by the photoelectric conversion elements 1. Through the amplifying transistors 2, the potential of the vertical signal line 8 decreases to become a signal potential depending on the decrease of the potential of the charge holding units. The line signal processing unit 91 detects a potential difference between the reference potential and a signal potential as a pixel signal. Subsequently, when the reset transistors 3 are turned ON while the potential of the power supply 10 is LOW, the potential of the charge holding units become LOW. Accompanying this, the amplifying transistors 2 are turned OFF.

In this way, when the potential of the power supply 10 is HIGH, turning the reset transistors 3 ON makes it possible to turn the amplifying transistors 2 ON and allow the pixel signals to be outputted from the pixel cells 88a. In other words, it is possible to enable the pixel cells 88a. In addition, when the potential of the power supply 10 is LOW, turning the reset transistors 3 ON makes it possible to turn the amplifying transistors 2 OFF and prevent the pixel signals from being outputted from the pixel cells 88a. In other words, it is possible to disable the pixel cells 88a. The pixel signals are read out in the duration between the time when the pixel cells 88a are enabled to the time when the pixel cells 88a are disabled. In the vertical signal reading-out period during which the pixel signals are read out from the pixel cells 88a to the vertical signal line 8 by the amplifying transistors 2 or the like, the potential of the power supply 10 becomes HIGH so that the pixel cells 88a are enabled. In addition, in the duration between (a) the ending time of the horizontal signal reading-out period in which pixel signals are read out from sampling capacitors 14-1 and 14-2 to the horizontal signal line 60 by the horizontal reading-out transistors 15-1 and 15-2 and the like and (b) the starting time of the vertical signal reading-out period, the potential of the power supply 10 changes from HIGH to LOW so that the pixel cells 88a are disabled. The vertical scanning circuit 5 controls the reset transistors 3 to turn ON when the potential of the power supply 10 becomes LOW in the duration between the ending time of the horizontal signal reading-out period and the starting time of the vertical signal reading-out period, when the potential of the power supply 10 becomes HIGH in the vertical signal reading-out period. Note that, since the other pixel cells 88 are structured in the same manner, they are not described here again.

The vertical scanning circuit 5 provides a HIGH-potential reset pulse to the reset signal line 6 connected to the respectively selected pixel cells 88a so that the pixel cells 88a in a line of the imaging unit 88 are selected, and the pixel signals of the selected pixel cells 88a are enabled. Subsequently, the vertical scanning circuit 5 provides a HIGH-potential read pulse to the read signal line 7 connected to the respectively selected pixel cells 88a so that the pixel signals of the selected pixel cells 88a are outputted. The vertical scanning circuit 5 provides a HIGH-potential reset pulse to the reset signal line 6 connected to the respectively selected pixel cells 88a so that the pixel cells 88a are disabled. The vertical scanning circuit 5 scans the pixel cells 88a in sequence on a line-by-line basis, regarding this operation as an operation cycle.

The load circuit 92 is composed of the load transistors 9-1 and 9-2 connected to the respective vertical signal lines 8, and intended for applying a constant current to the vertical signal line 8 when the line signal processing unit 91 detects the potential of the vertical signal line 8. In the period for applying a current, a HIGH potential is supplied to the load transistors 9-1 and 9-2. On the other hand, in the period for stopping supply of a current, LOW potential is supplied to the load transistors 9-1 and 9-2. The reference numbers of the load transistors are abbreviated hereinafter, for example as a load transistor 9. Note that the load transistor 9 is an example of the load unit of the present invention.

The horizontal scanning circuit 16 is intended for outputting the pixel signals of the pixel cells 88a of a particular row in the line signal processing unit 91 to the horizontal signal line 60.

This makes it possible to output the pixel signals of the pixel cells 88a of the selected line on a row-by-row basis.

The line signal processing unit 91 includes: line signal processing circuits 90-1 and 90-2, horizontal signal line reset transistor 17 connected to a signal line 70, and horizontal reading-out transistors 15-1 and 15-2 connected to the horizontal reading-out signal lines 16-1 and 16-2. The line signal processing circuits 90-1 and 90-2 include: sample hold transistors 11-1 and 11-2 connected to the sample hold signal line 30, clamp capacitors 12-1 and 12-2, clamp transistors 13-1 and 13-2 connected to the clamp signal line 40, and sampling capacitors 14-1 and 14-2 connected to the respective vertical signal lines 8. The reference numbers of the respective elements and line signal processing circuits are abbreviated hereinafter, for example a sample hold transistor 11. Note that the sampling capacitors 14 are examples of the holding units of the present invention.

Here, when the pixel cells 88a are reset, the line signal processing circuit 90 clamps the sampling capacitors 14, which become signal holding units, at the potential of the signal line 50. The variation of the vertical signal line 8 is also sample-held through the clamp capacitors 12 at the time of reading of the pixel cells 88. This makes it possible to cancel the variation of the thresholds of the amplifying transistors 2 in the respective pixel cells 88a and hold only the pixel signal components transmitted through the vertical signal line 8 in the sampling capacitors 14.

The horizontal signal line 60 is connected to the respective sampling capacitors 14, and transmits the pixel signals held by the sampling capacitors 14.

The load control circuit 21 controls the load transistors 9 to turn ON or OFF. More specifically, in the duration between the ending time of the horizontal signal reading-out period and the starting time of the vertical signal reading-out period, the load control circuit 21 changes the states of the load transistors 9 from ON to OFF so that the load transistor 9 functioning as loads is controlled to become disabled.

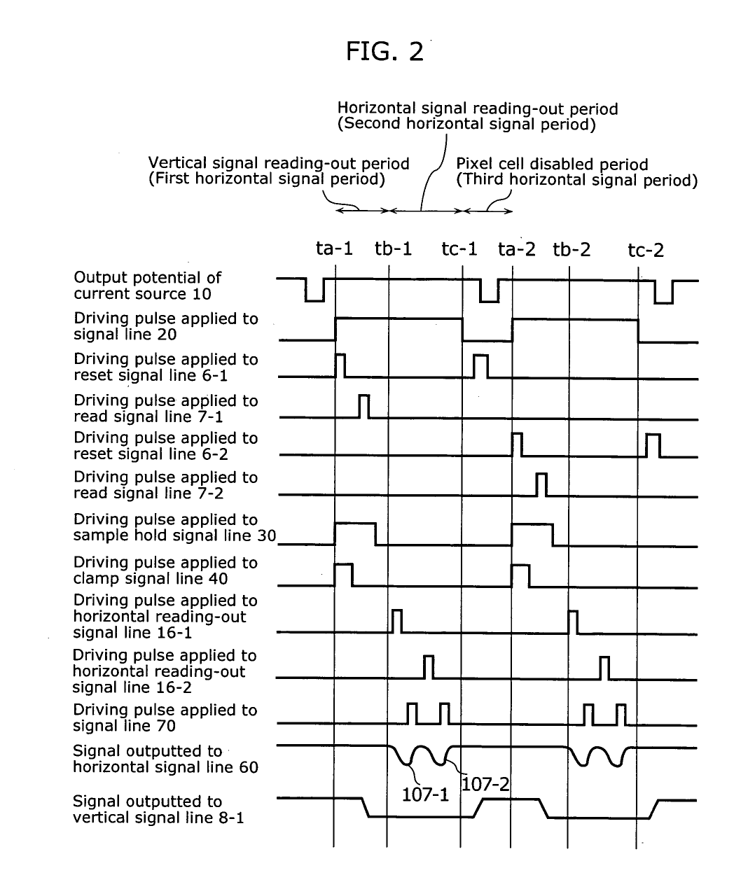

FIG. 2 is a timing chart for illustrating an operation of the solid-state imaging device in the first embodiment of the present invention.

The difference between the present invention and the conventional driving method of a solid-state imaging device disclosed in the Japanese Laid-open Patent Application No. 9-247537 is the rise timings of a driving pulse, from HIGH potential to LOW potential, applied to the signal line 20 connected to the gate of the pulse-driven load transistors 9. The timing in the present invention are tc-1 and tc-2 which are the boundaries between (a) the second horizontal signal period becoming a horizontal signal reading-out period and (b) the third horizontal signal period becoming a pixel cell disabled period for disabling the pixel cells 88a by turning the reset transistors 3 ON when the output potential of the power supply 10 is LOW, instead of being tb-1 and tb-2 which are the boundaries between (a) the first horizontal signal period becoming a vertical signal reading-out period and (b) the second horizontal signal period. Note that the first horizontal signal period starts by turning the reset transistors 3 ON when the output potential of the power supply 10 is HIGH, and the second horizontal signal period is finished by changing the state of the horizontal reading-out transistor 15 of the last stage from ON to OFF.

In the above-described solid-state imaging device, the load control circuit 21 applies a current, which is applied to the load transistors 9, also in the second horizontal signal period which is a horizontal signal reading-out period. At the time of transiting from the first horizontal signal period which is a vertical signal reading-out period to a second horizontal signal period, no current change happens, thus the signals 107-1 and 107-2 read out to the horizontal signal line 60 due to the absence of a current variation is not affected by a current variation of power supply voltage.

Therefore, it is possible to suppress a problem of an image defect due to horizontal shading in which light and shade is generated, accompanying a reduction in consumption electricity, on a display screen of the solid-state imaging device in a left to right direction.

In addition, in the solid-state imaging device, a driving current is prevented from flowing into the vertical signal line 8 by changing the potential of the signal line 20 connected to the gate of the load transistors 9 into LOW using the load control circuit 21 at the boundary between the second horizontal signal period and the third horizontal signal period. The second horizontal signal period is a horizontal signal reading-out period, and in the third horizontal signal period the pixel cells 88a are disabled. More specifically, the load transistors 9 in an ON state are turned OFF before turning the amplifying transistors 2 OFF by changing the potential of the power supply 10 from HIGH to LOW when the reset transistors 3 are in an ON state. Thus, it is possible to suppress a potential drop of the vertical signal line 8 when the potential of the power supply 10 is changed to LOW in the third horizontal signal period.

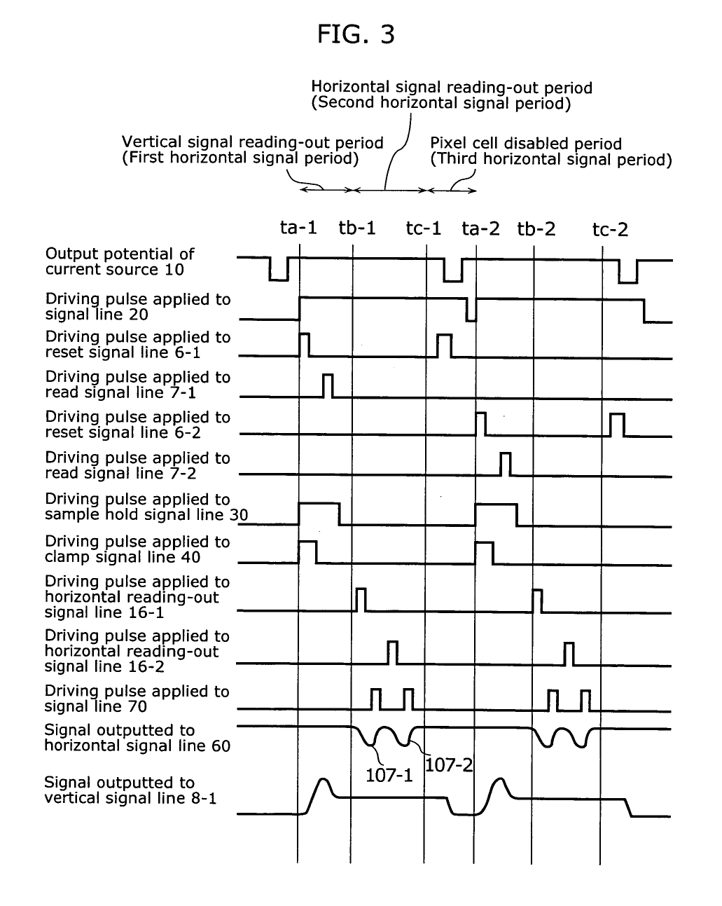

This will be described in detail with reference FIG. 3.

FIG. 3 is an example where a driving current is prevented from flowing into a vertical signal 8 at the proximity of a transition boundary between the third horizontal signal period and the first horizontal signal period.

During the third horizontal signal period, turning the reset transistor ON when the output potential of the power supply 10 is LOW disables pixel cells 88a. At this time, in the case where the solid-state imaging device operate according to the timing chart shown in FIG. 2, the load transistors 9 are in an OFF state and are not driven, and the source follower circuits made up of a load transistors 9 and an amplifying transistors 2 do not operate. Therefore, the potential of the charge holding units are not affected by the potential of the vertical signal line 8.

However, in the case where the solid-state imaging device operates according to a timing chart shown in FIG. 3, the load transistors 9 are turned ON during this period and are driven, and the source follower circuits made up of the load transistors 9 and the amplifying transistors 2 become enabled. As a result, the variation of the charge holding units which are the gate inputs affect the source potential of the amplifying transistors 2 so that the source potential changes from HIGH to LOW, the potential drop of the charge holding units are read out to the vertical signal line 8 connected to the source of the amplifying transistors 2. As the result, the potential of the vertical signal line 8 decreases.

Consequently, the reset transistors 3 are turned ON in ta-1 and ta-2 at which a vertical signal reading-out period starts, and the potential of the vertical signal 8 increases dramatically. This allows the vertical signal line 8 to couple with the charge holding units of the non-selected pixel cells 88a which have been disabled, and thus the potential of the charge holding units in the non-selected pixel cells 88a increase. As a result, the potential difference between the charge holding units of the selected pixel cells 88a and the charge holding units of the non-selected pixel cells 88a become smaller, and thus the dynamic ranges decrease.

However, in the case of operating the solid-state imaging device according to the timing chart shown in FIG. 2, the load transistors 9 are not driven during the third horizontal signal period. Thus, it is possible to control coupling of the vertical signal line 8 and the charge holding units in the non-selected disabled pixel cells 88a, and control the decrease of the dynamic ranges of the charge holding units. Here, the coupling accompanies a potential variation of the vertical signal line 8 in ta-1 and ta-2 which is a starting time point of a vertical signal reading-out period.

Note that, even in the case of operating the solid-state imaging device according to the timing chart shown in FIG. 3, no current variation is accompanied at the transition from the first horizontal signal period to the second horizontal signal period which are vertical signal reading-out periods, and therefore the signals 107-1 and 107-2 read out to a horizontal signal line 60 are not affected by the variation of the power supply. This is the same as in the case of operating the solid-state imaging device according to the timing chart shown in FIG. 2 although the drop timings of the potential of the signal line 20 of the load transistors 9 in FIG. 3 is different from the ones in the timing chart shown in FIG. 2.

Consequently, it is possible to suppress a problem of an image defect due to horizontal shading in which light and shade is generated, accompanying a reduction in consumption electricity, on a display screen of the solid-state imaging device in a left to right direction.

### Second Embodiment

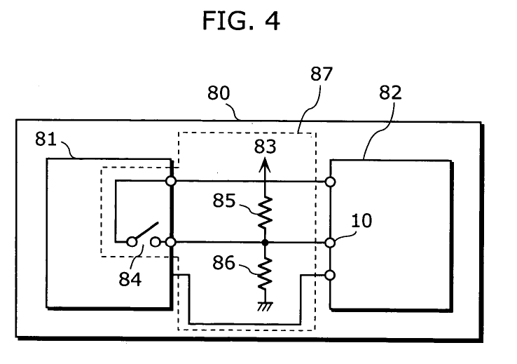

FIG. 4 is a diagram showing the structure of a camera in a second embodiment of the present invention.

This camera 80 is made up of a solid-state imaging device 82 shown in the first embodiment, a DSP (Digital Signal Processor) 81 which applies various kinds of driving pulses to the solid-state imaging device 82 and a power supply output circuit 87 which is placed between the solid-state imaging device 82 and the DSP 81 and supplies the power supply 10 to the pixel cells 88a.

The power supply output circuit 87 is made up of resistor 85 and 86 which generate LOW potential of the power supply pulse, a power supply 83 which generates HIGH potential of the power supply pulse, and a switch 84 which switches the potential of the power supply pulse between HIGH and LOW.

In the camera 80 of this embodiment, various kinds of driving pulses are applied from the DSP 81 to the solid-state imaging device 82, and the solid-state imaging device 82 operates according to the timing chart shown in FIGS. 2 and 3 of the first embodiment.

This makes it possible to secure wide dynamic ranges of the pixel signals from pixels, and thus it becomes possible to obtain a high-quality image.

Note that it is desirable that the camera 80 of this embodiment shown in FIG. 4 be used for a mobile camera which is to be mounted on a mobile phone, a digital still camera or the like.

In this way, in order to reduce the number of components, the structure of the camera 80 is not limited to the structure in FIG. 4 shown in this embodiment. For example, the power supply output circuit 87 may be included in a DSP 81, and the power supply output circuit 87 may be included in the solid-state imaging device 82 instead of being placed outside the solid-state imaging device 82.

In addition, the resistor 85 and 86 of the power supply output circuit 87 may be transistors.

In addition, the HIGH potential of the power supply pulse may be supplied from the power supply 83 through an output buffer instead of being supplied directly from the power supply 83.

In addition, the present invention is not limited to the above-described embodiments, and various modifications are possible in the exemplary embodiments without departing from the scope of this invention.

### INDUSTRIAL APPLICABILITY

The present invention is applicable to a MOS solid-state imaging device, and in particular to a digital still camera featuring high image quality, a mobile camera used for a mobile phone or the like.

What is claimed is:

1. A solid-state imaging device comprising:
pixel cells which are arranged in a matrix and perform photoelectric conversion;
vertical signal lines each to which pixel cells arranged in a same row are connected and which are operable to transmit pixel signals of said pixel cells in the row;
load units in each row which are connected to each of said vertical signal lines;
holding units in said each row which are connected to said each of said vertical signal lines and which are operable to hold the pixel signals of said pixel cells in said each row transmitted through said vertical signal lines;
a horizontal signal line which is connected to holding units in a same line and which is operable to transmit the pixel signals in said holding units in the line; and
a load control unit operable to control said load units,
wherein said load control unit is operable to control said load units functioning as loads to become disabled in a duration between an ending time of a horizontal signal reading-out period and a starting time of a vertical signal reading-out period, in the horizontal signal reading-out period the pixel signals being read out from said holding units to said horizontal signal line, and in the vertical signal reading-out period the pixel signals being read out from said pixel cells to said vertical signal lines.

2. The solid-state imaging device according to claim 1,
wherein said load units are load transistors, and
said load control unit is operable to control said load transistors in an ON state to turn OFF in a duration between the ending time of the horizontal signal reading-out period and the starting time of the vertical signal reading-out period.

3. The solid-state imaging device according to claim 1,
wherein said pixel cells each includes:
a photoelectric conversion unit operable to perform photoelectric conversion;
a charge holding unit operable to hold a signal charge generated by said photoelectric conversion unit;
a switch inserted between a pixel power supply which supplies potential to a pixel cell and said charge holding unit; and
an amplifying unit operable to output a pixel signal corresponding to the signal charge of said charge holding unit.

4. The solid-state imaging device according to claim 3,
wherein said pixel power supply is operable to supply potential, the potential being periodically changed between a first potential and a second potential which is higher than the first potential.

5. The solid-state imaging device according to claim 4,
wherein said pixel power supply is operable to supply the second potential in the vertical signal reading-out period and to change the potential to be supplied to said pixel cells from the second potential to the first potential in the duration between the ending time of the horizontal signal reading-out period and the starting time of the vertical signal reading-out period, and
said solid-state imaging device further comprising
a switch control unit operable to control said switches to turn ON, while the second potential is being supplied during the vertical signal reading-out period, and while the first potential is being supplied in the duration between the ending time of the horizontal signal reading-out period and the starting time of the vertical signal reading-out period.

6. The solid-state imaging device according to claim 5,
wherein said load control unit is operable to control said load transistors in an ON state to turn OFF before said pixel power supply changes the potential from the second potential to the first potential.

7. The solid-state imaging device according to claim 6,
wherein said pixel power supply is an internal pixel power supply for said solid-state imaging device.

8. The solid-state imaging device according to claim 6,
wherein said pixel power supply is an external pixel power supply for said solid-state imaging device.

9. A camera equipped with a solid-state imaging device which includes:
pixel cells which are arranged in a matrix and perform photoelectric conversion;
vertical signal lines each to which pixel cells arranged in a same row are connected and which are operable to transmit pixel signals of the pixel cells in the row;
load units in each row which are connected to each of the vertical signal lines;
holding units in the each row which are connected to the each of the vertical signal lines and which are operable to hold the pixel signals of the pixel cells in the each row transmitted through the vertical signal lines;
a horizontal signal line which is connected to holding units in a same line and which is operable to transmit the pixel signals in the holding units in the line; and
a load control unit operable to control the load units,
wherein the load control unit is operable to control the load units functioning as loads to become disabled in a duration between an ending time of a horizontal signal reading-out period and a starting time of a vertical signal reading-out period, in the horizontal signal reading-out period the pixel signals being read out from the holding units to the horizontal signal line, and in the vertical signal reading-out period the pixel signals being read out from the pixel cells to the vertical signal lines.

10. A method of driving a solid-state imaging device which includes:
pixel cells which are arranged in a matrix and perform photoelectric conversion;
vertical signal lines each to which pixel cells arranged in a same row are connected and which are operable to transmit pixel signals of the pixel cells in the row;
load units in each row which are connected to each of the vertical signal lines;
holding units in the each row which are connected to the each of the vertical signal lines and which are operable to hold the pixel signals of the pixel cells in the each row transmitted through the vertical signal lines; and
a horizontal signal line which is connected to holding units in a same line and which is operable to transmit the pixel signals in the holding units in the line,
said method comprising:
vertical reading-out of pixel signals from the pixel cells to the vertical signal lines;
horizontal reading-out of pixel signals from the holding units to the horizontal signal line; and
controlling of the load units functioning as loads to become disabled in a duration between an ending time of said horizontal reading-out and a starting time of said vertical reading-out.

11. The method according to claim 10, for driving the solid-state imaging device,
wherein the pixel cells each includes:
a photoelectric conversion unit operable to perform photoelectric conversion;
a charge holding unit operable to hold a signal charge generated by the photoelectric conversion unit;
a switch inserted between a pixel power supply which supplies potential to a pixel cell and said charge holding unit, the potential being periodically changed between a first potential and a second potential which is higher than the first potential; and
an amplifying unit operable to output a pixel signal corresponding to the signal charge of the charge holding unit.
wherein said vertical reading-out includes causing the power supply to supply the second potential in a state where the switches are turned ON, and
said controlling of the load units includes changing the potential which the power supply supplies in the state where the switches are turned ON from the second potential to the first potential, after controlling the load units functioning as loads to become disabled.
